(19) United States
(12) Patent Application Publication
(10) Pub. No.: US 2012/0188949 A1
(43) Pub. Date: Jul. 26, 2012

(54) WIRELESS COMMUNICATION DEVICE, WIRELESS COMMUNICATION SYSTEM, AND METHOD OF ROUTING DATA IN A WIRELESS COMMUNICATION SYSTEM

(75) Inventors: Apostolis K. Salkintzis, Attiki (GR); Scott T. Droste, Crystal Lake, IL (US)

(73) Assignee: MOTOROLA-MOBILITY, INC., Libertyville, IL (US)

(21) Appl. No.: 13/010,641

(22) Filed: Jan. 20, 2011

(51) Int. Cl. H04W 40/02; H04W 72/00

(52) U.S. Cl. 370/329

(57) ABSTRACT

A wireless communication system (5) comprises a wireless communication device 40 adapted to communicate an IP flow (35) simultaneously over multiple heterogeneous network access interfaces (46, 48). A flow combine and split function in the network combines the multiple IP sub-flows for communication with another network node such as an application server (44). A wireless communication device for use in such a system, and a method of routing data in such a system are also provided.

### FIELD OF THE DISCLOSURE

This disclosure relates to wireless communication devices, a wireless communication system comprising such devices, and a method of routing data in such a wireless communication system, in which the wireless communication devices are adapted to communicate over a plurality of heterogeneous radio interfaces.

### BACKGROUND OF THE DISCLOSURE

The 3^{rd} Generation Partnership project 3GPP has specified methods that allow a wireless communication device to determine preferable radio accesses for a specific Internet Protocol (IP) flow and attempt to route an IP flow on the most preferable radio access (for example see 3GPP technical specifications TS 23.261, TS 23.402 and TS 24.312 which are incorporated by reference herein). This determination is based on inter-system routing policies (ISRP), each of which contains one or more Filter Rules that specify which radio accesses (in priority order) should be used for traffic that matches specific criteria. IP traffic that matches the criteria in a Filter Rule of an ISRP is transmitted on the most preferable radio access of the ISRP, if it is available and connected. If it is not available or connected, it may trigger a discovery and attachment procedure in the wireless communication device.

According to TS 23.402, v10.2.0, clause 4.8.2.1, each inter-system routing policy includes the following information:

Validity conditions, i.e. conditions indicating when the provided policy is valid;

One or more Filter Rules, each one identifying a prioritized list of access technologies/access networks which shall be used by the mobile device when available to route traffic that matches specific IP filters and/or specific Access Point Names (APNs).

A filter rule also identifies which radio accesses are restricted for traffic that matches specific IP filters and/or specific APNs (e.g. WLAN is not allowed for traffic to APN-x). A Filter Rule may also identify which traffic shall or shall not be non-seamlessly offloaded to a WLAN when available, if the wireless communication device supports the non-seamless WLAN offload capability specified in clause 4.1.5 of TS 23.402 v10.2.1.

The notion of an IP flow is well known in the prior art, for example see U.S. Pat. No. 7,190,668. An IP flow is a sequence of packets or information bits that share some common properties, for example being all destined to the same IP address and port number and carrying data cast in the same IP protocol such as HTTP, UDP, TCP or similar.

As shown in FIG. 1, an IP flow is typically created by matching a sequence of IP packets 2 against some criteria in a filter rule 3. Packets that match the criteria of a particular filter rule are said to belong to the same IP flow 4. In FIG. 1, the IP packet source 5 represents any data source (e.g. one or more data applications) that generate data which is then delivered to and processed by the IP protocol stack in a communication device. The processing procedure by the IP protocol stack segments the data into packets and adds header information to each packet such as IP, TCP, UDP, ICMP and HTTP headers. When these packets pass through a filter rule 3, the filter rule may check header information in each packet and, for example, match packets with Destination Address=193.92.12.1 and Protocol=6 (TCP) and TCP Destination Port=80 (HTTP). Alternatively, the filter rule may match packets with a specific payload type, for example packets that carry voice encapsulated with the Real Time Protocol (RTP). In another example, a filter rule may match packets generated by the same data application or packets destined to the same network interface or to the same logical connection, such as a PPP connection or an APN as defined in 3GPP TS 23.003.

Possible wireless communication device architectures that support ISRP and simultaneous transmission of IP flows over multiple radio access interfaces are shown in FIGS. 2a and 2b. In the architecture of FIG. 2a, the baseband implementation 10 comprising a mobile IP module 11 (for example using a DSMIPv6 module specified in 3GPP TS 23.261 v10.1.0) receives IP flows 12, 14 from upper layers including an application layer 16 and a transport/IP layer 18. The mobile IP module 11 compares the IP flows 12, 14 against a list of filter rules in a preconfigured/installed inter system routing policy (ISRP) 20. When an IP flow matches a filter rule in an ISRP, the IP flow is transmitted on the most preferable radio access (if available) contained in the ISRP, for example either on a wireless LAN radio access interface 22 or a 3GPP cellular radio access interface 24.

In the architecture of FIG. 2b, the IP flow detection and comparison against the preconfigured/installed ISRP 20 is performed by the IP implementation 30 in the host processor of the wireless communication device after routing from the application layer 16 through a transport layer 32. Here, the IP layer 30 needs to implement “policy based routing” and route outgoing traffic not based on IP destination addresses but based on the preconfigured/installed ISRP 20.

One difference between the two architectures of FIGS. 2a and 2b is that the architecture of FIG. 2a enables IP flow mobility, i.e. it can seamlessly transfer an IP flow from one radio access interface to another when required. For doing so, however, it requires a corresponding mobile IP agent in the core network, such as a DSMIPv6 home agent as specified in TS 23.261. Such an agent may typically be implemented in the packet data network gateway PDN-GW, or gateway GPRS support node GGSN, and provides a core network anchor for the user plane and undertakes the switching of downlink data traffic to facilitate handovers of IP flows. The architecture of FIG. 2b, however, may switch an IP flow from one radio access interface to another in a non-seamless manner, that is, without preserving the IP address of the wireless communication device associated with the IP flow.

Although not expressly shown, in both of FIGS. 2a and 2b the illustrated elements may additionally handle IP flows incoming from the wireless LAN and cellular radio access interfaces, with the mobile IP module 11 routing the flows upwards through transport layers to the application layer 16.

Transmitting different IP flows over different radio access interfaces (as discussed above) can feature several benefits. For example, based on the provisioned ISPR policies, a wireless communication device may prefer to route voice over IP (VoIP) flows on a 3GPP cellular radio access interface to benefit from guaranteed quality of service, and offload all other traffic to wireless local area networks such as WLAN, when available. In streaming scenarios, the wireless communication device may prefer to route real time streaming protocol (RTSP) signalling on a 3GPP cellular radio access interface in order to facilitate subscriber identification and charging, and route RTP/RTCP traffic on a wireless local area network in order to offload bandwidth intensive media streams from the cellular network.

### BRIEF DESCRIPTION OF THE DRAWINGS

A wireless communication device, a wireless communication system comprising such a device, and a method of routing data in such a wireless communication system, in accordance with the disclosure will now be described, by way of example only, with reference to the accompanying drawings in which:

FIG. 1 illustrates the identification of multiple IP flows originating at an IP packet source;

FIGS. 2a and 2b show the routing of separate IP flows over heterogeneous radio access interfaces according to the prior art;

FIG. 3 shows a telecommunications network in which a single IP flow is routed as two sub-flows over heterogeneous radio access interfaces in accordance with an example embodiment of the present disclosure;

FIGS. 4a and 4b illustrate how the arrangement of FIG. 3 may be implemented in a wireless communication device;

FIG. 5 shows further details of an implementation of the telecommunications network of FIG. 3;

FIGS. 6a and 6b illustrate protocol architectures for implementing a wireless communications device according to an example embodiment of the present disclosure; and

FIGS. 7 and 8 show detailed signalling flows according to example embodiments of the present disclosure.

### DETAILED DESCRIPTION OF THE DRAWINGS

A wireless communication device for use with the wireless communication system in accordance with the disclosure may be a portable or handheld or mobile telephone, a Personal Digital Assistant (PDA), a portable computer, portable television and/or similar mobile device or other similar communication device. In the following description, the communication device will be referred to generally as a UE (user equipment) for illustrative purposes and it is not intended to limit the disclosure to any particular type of wireless communication device.

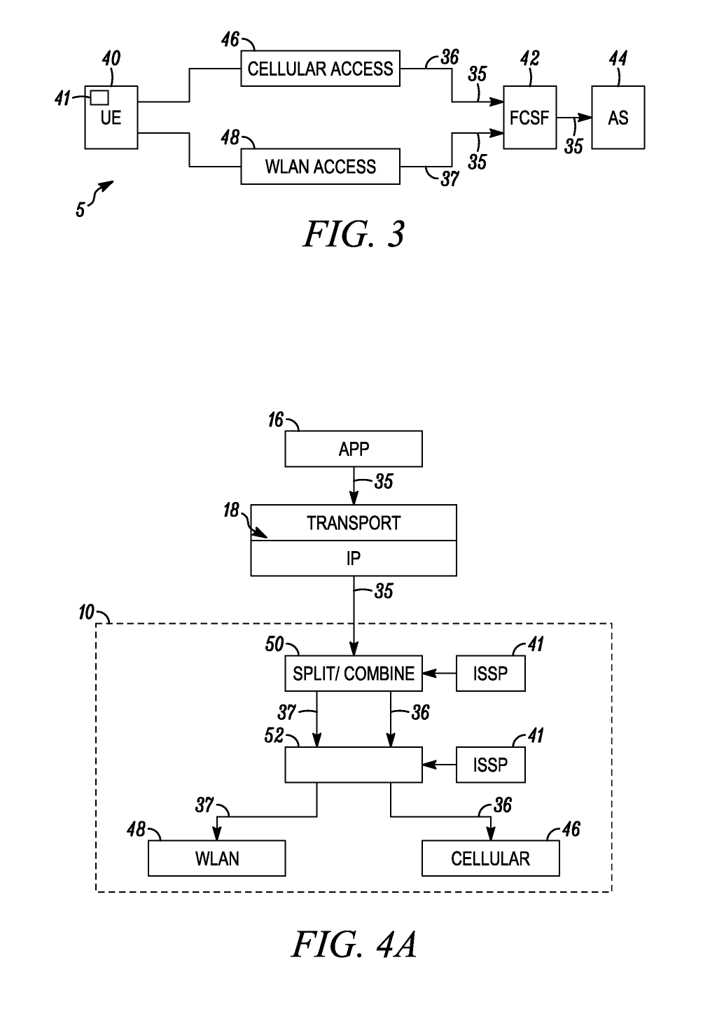

A UE in accordance with the disclosure provides communication of a single IP flow over multiple radio access interfaces simultaneously. FIG. 3 shows wireless communication system 5 comprising a plurality of UEs. A UE 40 having a single IP flow 35 is in communication with a distant proxy function, server or element, which is generally referred to below as a flow combine and split function (FCSF) 42. In a typical scenario, the UE 40 wants to access the services provided by an Application Server (AS) 44 deployed by a mobile network operator or by a third-party application provider, to communicate with another network peer, node or user. For this purpose, a new IP flow 35 is created, for example from a UE application that requests a TCP socket connection. Based on an inter-system sub-flow policy (ISSP) 41, the UE 40 may determine that this IP flow 35 should be routed in a conventional way across a single radio access interface. Alternatively, however, the UE may determined that the IP flow 35 can or should be transmitted across multiple radio access interfaces simultaneously, for example across a cellular radio access interface 46 (such as a 3GPP radio access interface, e.g. GERAN, UTRAN, E-UTRAN) and a wireless LAN access (such as IEEE 802.11b, IEEE 802.11g, IEEE 802.11n, etc). The inter-system sub-flow policy (ISSP) may include some or all of the following information:

Validity conditions, i.e. conditions indicating when the policy is valid;

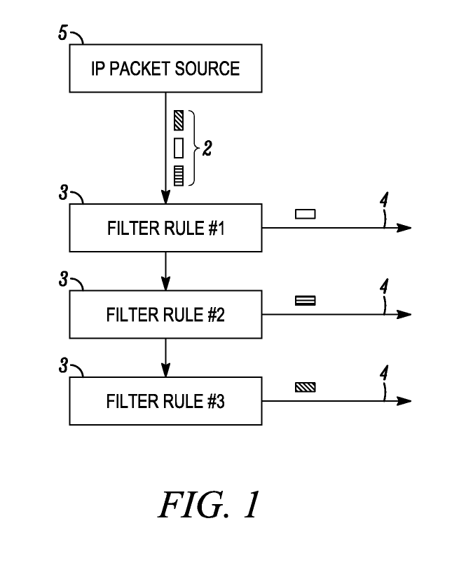

One or more filter rules, each one identifying (i) a prioritized list of radio access interfaces (in the form of access technologies and/or access networks) which shall be used by the mobile device when available to simultaneously transmit a single IP flow, (ii) the matching criteria that specifies the IP flow (see FIG. 1) and (iii) a scheduling policy indicating how the IP flow that matches the criteria should be split across the list of prioritized radio access interfaces.

The priorities assigned to radio access interfaces in a filter rule indicate which radio access interface shall be used first for transmitting the IP flow. As explained below, the transmission of a single IP flow in the arrangement of FIG. 3 may start first on a single radio access interface with communication over a second interface being added subsequently.

As an example, an ISSP policy 41 may indicate:

Validity conditions: PLMN=(MNC, MCC)

Filter Rule 1:
Prioritized Accesses=3GPP access (priority 1), WLAN access (priority 2)
Criteria=Destination Address 192.108.114.1, Protocol 6 (TCP), Destination Port 80 (HTTP)

Scheduling Policy=Multipath TCP

Based on the above ISSP, when the UE 40 is registered in the specific PLMN (public land mobile network) identified by the validity conditions (i.e. when the ISSP is valid), then all IP packets with Destination Address 192.108.114.1, Protocol 6 (TCP) and Destination Port 80 (HTTP) must be simultaneously transmitted over a 3GPP access and a WLAN access (if both are available and connected) by employing a Multipath TCP scheduling policy. This policy indicates that the transmission scheduling on the 3GPP and WLAN accesses must be performed as specified by the Multipath TCP protocol (see draft-ietf-mptcp-architecture-04 and draft-ietf-mptcp-congestion-01), i.e. based on the TCP congestion control. By means of this policy, the UE 40 will perform a dynamic load balancing across 3GPP and WLAN access interfaces based on the determined congestion level in each access. When, for example, the 3GPP access interface starts being congested (as determined by the TCP congestion control algorithm), the UE 40 will schedule less IP flow traffic on the 3GPP access interface and more IP flow traffic on the WLAN access interface. As congestion increases more and more, the UE will schedule less and less IP flow traffic on the 3GPP access interface. In the extreme case that 3GPP access becomes unavailable (either due to congestion or due to lack of radio signal) the UE will schedule all IP flow traffic on the WLAN access interface. So, employing two access interfaces to transmit the same IP flow simultaneously can considerably improve communication in a mobile environment.

In the case that one radio access interface becomes unavailable, an ongoing session is not disrupted or otherwise discontinued but is maintained over another radio access interface. Note that the scheduling policy specifies how a specific IP flow is split into two sub-flows, each one transmitted on a different radio access interface.

As another example, an ISSP policy 41 may indicate:

Validity conditions: Roaming

Filter Rule 1:
Prioritized Accesses=WLAN (priority 1), 3GPP access (priority 2)
Criteria=Protocol 17 (UDP), RTP voice

Scheduling Policy=Loading balancing 50%

Based on the above ISSP, when the UE 40 is roaming (i.e. using any PLMN except its home PLMN), all UDP/RTP packets that carry voice as identified by the RTP payload type (see RFC 3551) must be simultaneously transmitted over a WLAN access and a 3GPP access by employing a 50%-50% load balancing. In this case, the UE will start first transmitting the IP flow on the WLAN access interface (if available), will then setup a second transmission path over 3GPP access and finally will schedule half of the IP flow traffic on WLAN access and half of the IP flow traffic on 3GPP access. No congestion control is performed in this case since the TCP protocol is not used.

Many other scheduling policies may be envisioned, for example, a policy indicating that all IP flow traffic must be scheduled on one radio access (the highest priority one) and the other radio access is used to duplicate some percentage of the IP flow traffic. In this case, the UE employs transmission access diversity where part or all the IP flow packets are transmitted over multiple radio accesses simultaneously in order to increase transmission reliability, i.e. reduce the packet error rate at the receiving side.

The ISSP policies discussed above may either be statically provisioned in the UE (e.g. during manufacturing or post manufacturing by means of a device configuration process) or be sent to the UE by a network element such as the Access Network Discovery and Selection Function (ANDSF) specified in 3GPP specification TS 23.402 v10.2.1. When sent to UE by a network element, these policies can be updated, deleted, or otherwise modified as necessary, for example with a device management protocol such as OMA DM.

To enable routing of the IP flow 35 across multiple radio access interfaces, the UE 40 does not establish a connection directly to the other network node, which may be the application server 44 illustrated in FIG. 3 or another node, but instead uses the FSCF 42 as an intermediate proxy function. In other words, the UE 40 establishes a first wireless connection to the FSCF 42, which behaves as a session-layer proxy, for example as an HTTP or SOCKS5 proxy, and the FSCF 42 then connects to the application server 44 via a separate connection. The first connection between the UE and the FCSF is established over the most preferable radio access interface (based on the policy 41), say, over a 3GPP cellular access 46. Subsequently, when WLAN access becomes available, the UE establishes a second connection to the FCSF over WLAN 48 and informs the FCSF 42 that this second connection should be linked with the first connection. This way, the FCSF 42 can combine upstream traffic from the UE 40 across the said first and second connections to form first and second sub-flows 36, 37 of IP flow 35. In addition, the UE 40 may configure its transmission stack so that upstream traffic to the application server 44 is transmitted across both the said first and second connections in the first and second sub-flows 36, 37. In effect, the IP flow 35 between UE and FCSF is provided on a multipath connection that can be realized, for example, by means of Multipath TCP, discussed in the relevant IETF documents such as http://tools.ietf.org/html/draft-ietf-mptcp-architecture-04 which is herein incorporated by reference.

If it is determined that the IP flow 35 should not be routed across multiple radio access interfaces, for example because the ISSP 41 prohibits that particular flow from flow splitting, then the FCSF 42 is not used and the IP flow is routed to the application server 44 without traversing the FCSF 42, as per the prior art. In this case, the most preferable radio access that should be used to carry this IP flow is determined by the ISRP that is currently specified in 3GPP TS 23.402 v10.2.1.

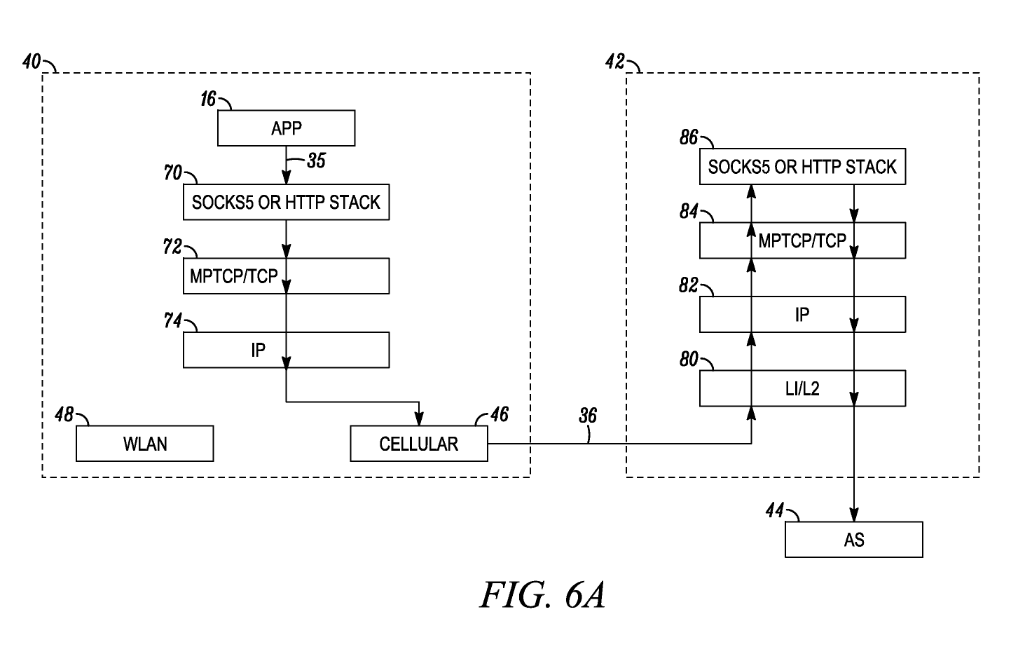

Although FIG. 3 illustrates the routing of an upstream IP flow from the UE 41 to the application server 44, the system will typically be configured to also route downstream IP flows from the application server 44 to the UE 41. The same ISSP 41 may be used to determine the way in which the downstream flow is routed, through communication with the FCSF 42 where downstream flows are split, or the sub-flow policy may be provided to the FCSF by another network element such as the PCRF 58 illustrated in FIG. 5.

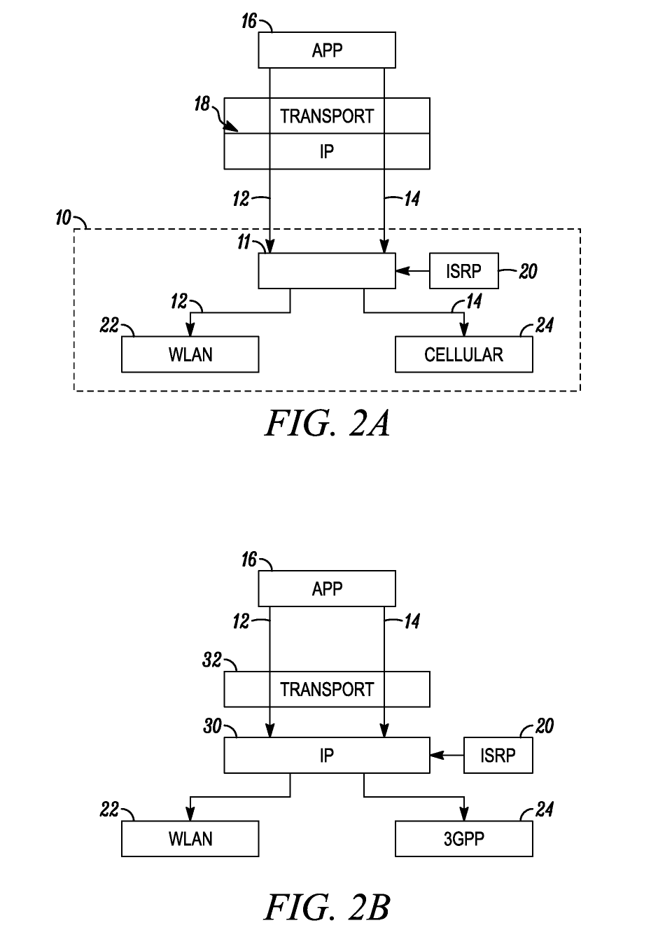

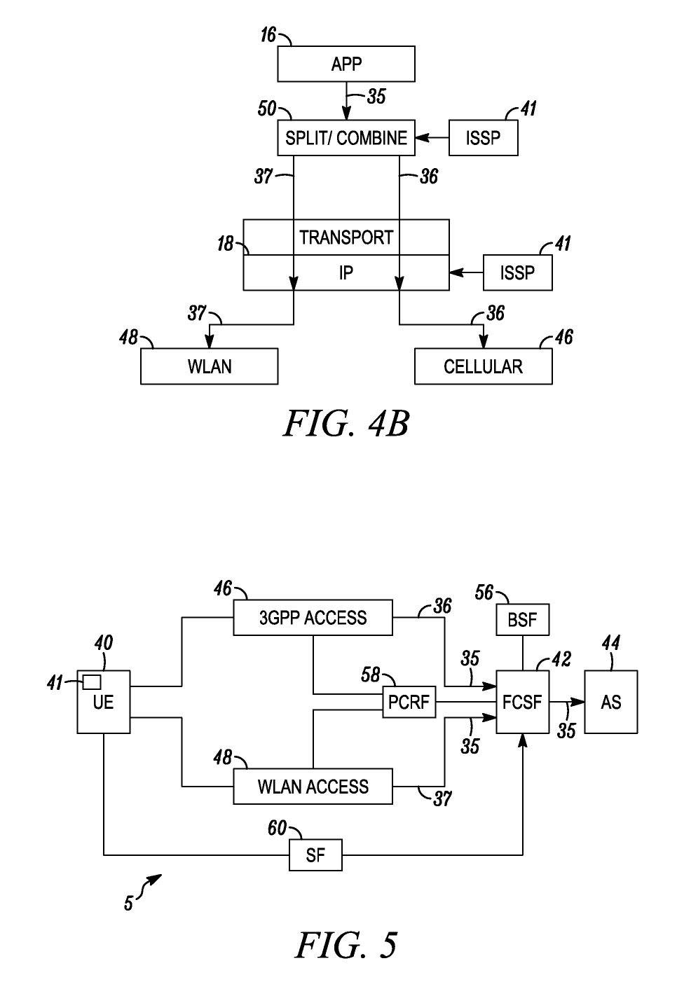

FIGS. 4a and 4b show two typical UE architectures that can be used to enable transmission of the single IP flow 35 across multiple radio access interfaces. As with FIG. 2a, the architecture of FIG. 4a implements all required functionality in the baseband processor 10, which now also includes a flow split/combine function 50 that detects an IP flow 35 received from application layer 16 via transport/IP layer 18 and compare it against Filter Rules contained in the provisioned inter-system sub-flow policy 41. If the IP flow 35 matches a Filter Rule that indicates the flow shall be able to be transmitted across a first radio access interface and a second radio access interface simultaneously, the IP flow is not directly connected to the addressed application server 44, but instead a proxy connection is created by the mobile IP module 52 to the FCSF 42 first over the first radio access interface 46. If the second radio access interface 48 is available (or when it becomes available), a second connection between the UE 40 and FCSF 42 is established by the mobile IP module 52 over the second radio access interface 48 and is logically linked to the first connection.

After that, the flow split/combine function 50 splits the IP flow 35 into the two upstream sub-flows 36, 37, each one transmitted over the available first and second connections to FCSF 42. In the opposite direction, the flow split/combine function 50 is adapted to combine pairs of downstream sub-flows (not shown in FIG. 4a) and deliver a corresponding single IP flow to the application layer 16 through the transport/IP layer 18. The splitting algorithm used by the flow split/combine function can be implementation dependant or can be specified by the provisioned ISSP 41, for example when required by the network operator to do certain types of load-balancing between the two connections.

The architecture shown in FIG. 4b implements equivalent functionality to that of FIG. 4a, but with the flow split/combine function 50 located between the application layer 16 and the transport/IP layer 18. In the upstream direction shown in FIG. 4b, the flow split/combine function 50 splits a certain IP flow specified by ISSP 41 into multiple sub-flows by mean of a scheduling policy, which is also specified by ISSP 41 (for example, a Multipath TCP scheduling or a 50%-50% load balancing policy could be used to create sub-flows). Subsequently, the IP layer routes the created sub-flows to the radio access interface that is the most preferable for each one, as specified by ISSP 41. As mentioned above, the flow split/combine function 50 and the signalling between the UE and FCSF can be based on Multipath TCP (for TCP flows). For UDP flows, a separate signalling interface Sf between the UE and FCSF is required, as discussed below.

FIG. 5 shows how the arrangement of FIG. 3 may be implemented in a telecommunications network In addition to the components shown in FIG. 3, a bootstrapping server function BSF 56 in communication with the FCSF 42 is used for authenticating UEs requesting to connect to FCSF, for example according to the known Generic Bootstrapping Architecture (GBA) specified in 3GPP TS 33.220.

A PCRF network entity 58 (policy and charging rules function), a defined 3GPP specified network entity (see 3GPP TS 23.203), provides the FCSF 42 with policy and control information. As in the prior art, this information may include such aspects as the quality of service that should be provided to specific IP flows and how IP flows should be charged. Additionally, as an additional functionality to support the IP flow splitting/combining of the present disclosure, the PCRF 58 may provide to FCSF 42 policies that indicate how downstream IP flows can be split into individual sub-flows for transmission to UE on different radio access interfaces. Moreover, the PCRF authorizes UEs requests to transmit certain IP flows on multiple radio accesses in the upstream direction.

A new interface Sf 60 between the UE 40 and FCSF 42 is used to transport signalling between UE and FCSF required to establish multiple sub-flow paths 36, 37. If Multipath TCP (MPTCP) is used, the interface Sf 60 may not be required because MPTCP provides the means for managing multiple paths. However, when MPTCP is not used or when multiple paths for flow types not supported by MPTCP such as UDP flows are required, the interface Sf 60 facilitates the necessary signalling between UE and FCSF. Interface Sf could be an HTTP/XML based interface, in which case an appropriate XML schema may be specified.

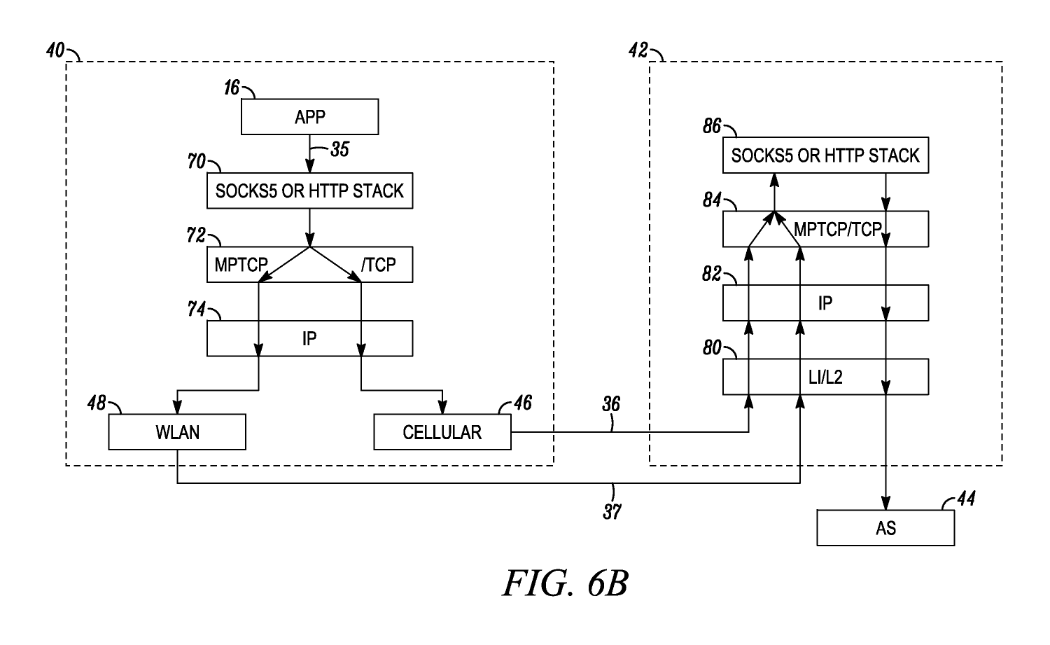

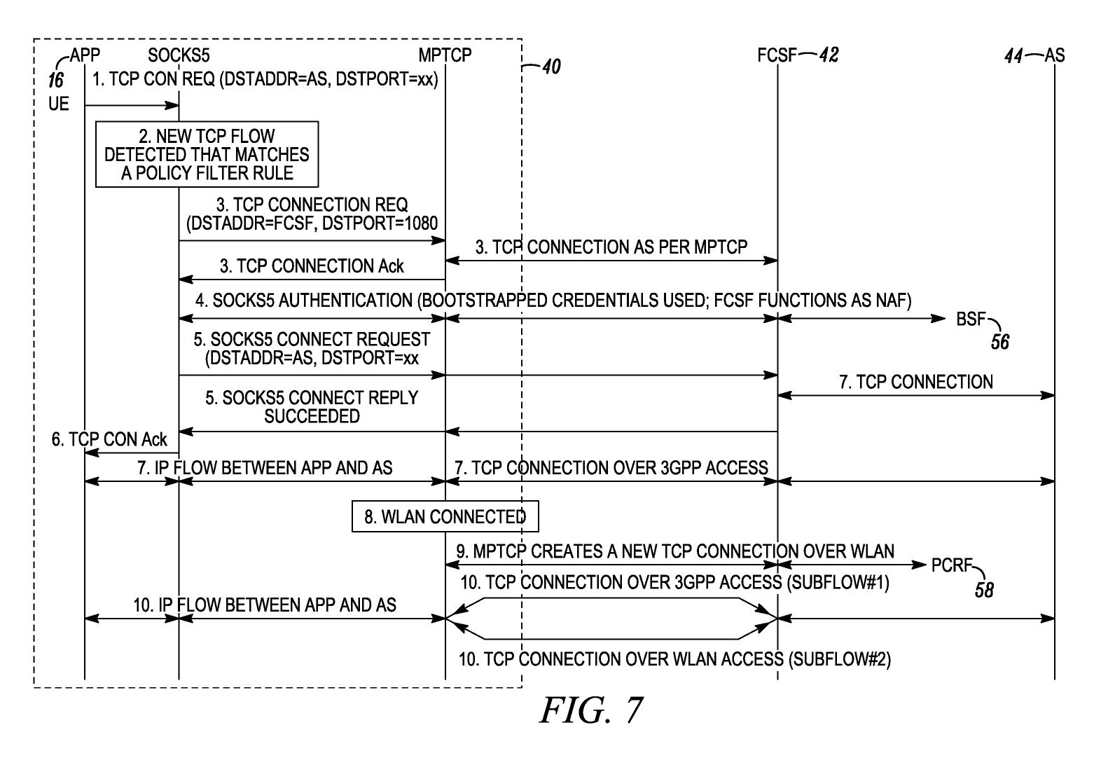

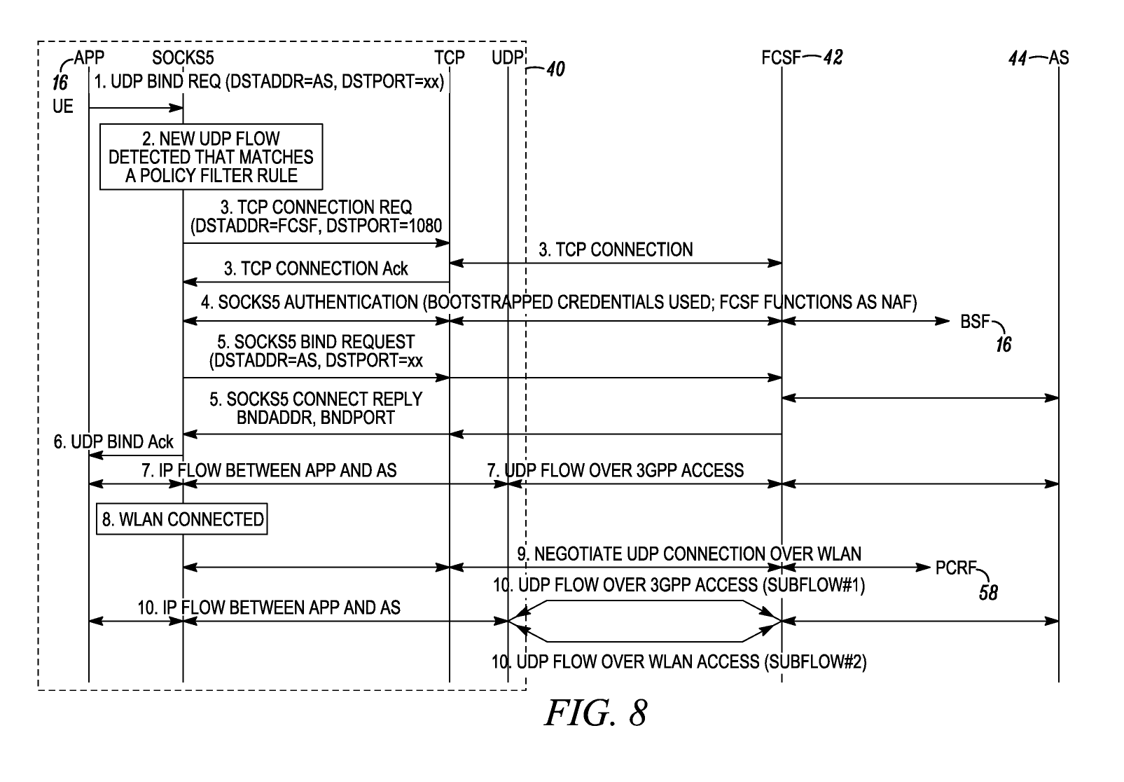

FIGS. 6a and 6b illustrate suitable protocol architectures in the UE 40 and FCSF 42 when MPTCP is used in addition to a connection establishment between the UE and FCSF over a cellular radio access interface. This connection establishment is more thoroughly discussed below in relation to FIGS. 7 and 8 but is also discussed here briefly in order to explain the function of each protocol in the protocol architecture. The application layer 16 makes a TCP socket request or an HTTP request to a SOCKS5 or HTTP stack 70 in order to establish communication with the Application Server 44. Based on the provisioned inter system sub-flow policy 41, the SOCKS5 or HTTP stack 70 identifies that the IP flow that will be transmitted on the requested TCP socket or HTTP session should be transferred on two radio access interfaces simultaneously, so it decides that the connection must go through the SOCKS5 or HTTP Proxy 86 in the FCSF 42. This proxy is required when the Application Server does not support MPTCP. In response, the SOCKS5 or HTTP stack 70 sends a Multipath TCP (MPTCP) connection request to the SOCKS5 or HTTP Proxy 86, which goes through an MPTCP/TCP layer 72, and an IP layer 74 to the 3GPP cellular radio access interface 46. In the FCSF 42 the MPTCP connection request is passed from Layer 1 and Layer 2 (L1/L2 layer) 80 up through IP layer 82, MPTCP/TCP layer 84 and SOCKS5 or HTTP proxy 86. When the MPTCP connection is established between SOCKS5 or HTTP stack 70 and SOCKS5 or HTTP proxy 86, a second connection is established between the SOCKS5 or HTTP proxy 86 and the Application Server 44. This is a normal TCP connection. After that, the SOCKS5 or HTTP proxy 86 binds the two established connections and relays packets between them. The benefit of using the SOCKS5 or HTTP proxy 86 is that it operates on top of MPTCP and can thus support transmission of a single IP flow to the UE over multiple radio access interfaces (by splitting the IP flow into multiple sub-flows according to a scheduling policy). It can also receive a single IP flow from the UE over multiple radio accesses and combine the received sub-flows into a single IP flow that is forwarded to the Application Server 44.

FIG. 6b shows how the establishment of a connection through wireless LAN (WLAN) radio access interface 48 triggers the MPTCP/TCP layer 72 in the UE, to add a second communication path between the UE and FCSF for supporting the same IP flow that is already transmitted over the 3GPP radio access (as discussed in FIG. 6a). After the WLAN radio access 48 is connected, the MPTCP/TCP layer 72 establishes a second TCP connection with the MPTCP/TCP layer 84 in the FCSF 42 as specified by the Multipath TCP protocol. When this connection is established, the UE 40 then splits the IP flow 35 transmitted by the application layer 16 into two sub-flows 36, 37 according to the provisioned scheduling policy in ISSP and transmits one sub-flow on the 3GPP access interface and the other sub-flow on the WLAN access interface. Similarly, the FCSF 42 splits the IP flow received from the Application Server 44 into two sub-flows according to the ISSP policy received from PCRF 58 shown in FIG. 5 and transmits one downstream sub-flow (not shown) on the 3GPP access interface and the other downstream sub-flow (not shown) on the WLAN access interface.

A detailed signalling flow corresponding to the protocol architecture diagrams of FIGS. 6a and 6b, in which MPTCP is used, is shown in FIG. 7. The UE 40 is shown by a broken line box so labelled. It is assumed in this figure that a SOCKS5 proxy is used but any other type of proxy is equally applicable. At step 1, the application layer 16 requests a new TCP connection to an application server AS 44. This request goes to the SOCKS5 layer in the UE 40 because the application is configured to use SOCKS5 or because the UE is configured to use SOCKS5 for all TCP and UDP connections independent of any application settings. The SOCKS5 layer (which is part of the flow split/combine function 50 shown in FIG. 4b) determines by means of the installed inter-system sub-flow policy (ISSP) 41 (not shown) that the new TCP connection will carry an IP flow which can be split across 3GPP cellular and WLAN radio access interfaces and that an MPTCP scheduling policy should be used. In response, the SOCKS5 layer in the UE 40 discovers an FCSF function 42 in the network (e.g. by means of DNS or any other service discovery mechanism) and establishes a MPTCP connection with the SOCKS layer in the FCSF in step 3.

In step 4, the FCSF 42 authenticates the UE 40 by means of SOCKS5 protocol signalling. A variety of methods could be used to authenticate the UE 40, but FIG. 7 assumes that the Generic Bootstrapping Architecture (GBA) is used and thus an interface exists between the FCSF and the Bootstrapping Server Function (BSF) 56 specified in 3GPP TS 33.220. After the authentication step 4, the FCSC 42 may optionally contact PCRF 56 to make sure the UE is authorized to use the multipath communication services of FCSF 42. After the UE 40 is successfully authenticated, a SOCKS5 Connection Request is sent to the FCSF 42, which requests the SOCKS5 layer in FCSF to establish a new TCP connection to the Application Server (AS) 44. When this connection is successfully established the FCSF responds with a SOCKS5 Connect Reply (see step 5). In turn, the TCP connection request of step 1 is acknowledged (step 6). After this point, the application in the UE starts communication with the AS over the established connection through the FCSF (step 7).

Later, in step 8, the WLAN radio access interface becomes available and connected. This triggers the MPTCP protocol in the UE 40 to request and establish a new TCP connection to the FCSF 42 over WLAN access that is associated with the existing TCP connection to FCSF over 3GPP access established before in step 3. At this point, the FCSF may contact the PCRF 58 to check if the UE 40 is authorized to initiate a multipath connection for its communication with the AS 44 and, if so, to download the applicable policies that instruct the FCSF 42 how to perform downstream scheduling across the two TCP connections on 3GPP access and WLAN access interfaces. Finally, in step 10, the IP flow sent by the application layer 16 is scheduled (by MPTCP in the UE) over the established TCP connections on 3GPP access and WLAN access interfaces and similarly the IP flow sent by AS is scheduled (by MPTCP in the FCSF) over the established TCP connections on 3GPP access and WLAN access interfaces. Both the UE 40 and FCSF 42 combine the sub-flows received over the different radio access interfaces and deliver a single IP flow to the application layer 16 and AS 44 respectively.

Note that the application layer or AS may generate more that one IP flow, for example, if the AS is a media streaming server, one IP flow for RTSP signalling and a second IP flow for media streaming. In such case, the MPTCP layer in the UE and FCSF decide which IP flows can be split into separate sub-flows according to their respective ISSP and schedule these IP flows on one or more radio access interfaces accordingly. For example, the RTSP signalling flow could be scheduled on the 3GPP radio access interface only and the media streaming flow could be scheduled on both interfaces by an MPTCP scheduling policy in order to benefit from higher throughput and better reliability and availability.

Note also that in FIG. 7 the interface Sf 60 illustrated in FIG. 5 is not required since the MPTCP protocol provide an in-band method for negotiating and establishing multipath TCP connections. However, when MPTCP is not used a new HTTP/XML protocol over the interface Sf 60 could be used, which will support the required functionality for all possible TCP and UDP flow scenarios.

A similar detailed signalling flow for the case in which a UDP flow is required is shown in FIG. 8. This is similar to the signalling flow described for FIG. 7 but here the MPTCP protocol is not used because it is not applicable to UDP flows.

As before, the SOCKS5 layer in the UE 40 determines a new bind request for a destination address and/or port with which multipath communication over multiple access interfaces is allowed (according to the provisioned ISSP). In response, the UE 40 discovers an FCSF 42 function in the network (if not already known), establishes a TCP connection to the SOCKS5 layer in FCSF (step 3) and then the UE is authenticated (step 4) and optionally authorized (e.g. by PCRF or another element) to use the multipath communication services provided by FCSF 42. In step 5, the SOCKS5 layer in the UE sends a SOCKS5 Bind request to FCSF which triggers the FCSF to establish a new UDP socket with the AS's IP address and UDP port. In step 7, the UDP flow is being exchanged between the UE 40 and AS 44 through the SOCKS5 proxy function in FCSF 42. When WLAN access is later connected (step 8), a UDP communication path over WLAN is negotiated between the UE and FCSF. This negotiation takes place over WLAN or 3GPP cellular radio access interfaces and uses the Sf protocol, which could be a simple XML-based protocol implemented over HTTP or another transport scheme. During this negotiation, the FCSF 42 may request PCRF 58 to authorize the establishment of this path and to provide FCSF with the applicable ISSP policies for the downstream direction. If authorization from the PCRF is successful, a second UDP communication path between UE and FCSF is established over the WLAN access network (step 9). In the final step 10, parts of the IP/UDP traffic flow are now transmitted between UE and FCSF as a first sub-flow over the first communication path on the 3GPP access interface and parts of the IP/UDP traffic flow are transmitted between UE and FCSF as a second sub-flow over the second communication path on the WLAN access interface. The traffic on these two sub-flows is determined by the scheduling policy specified in the ISSP. For example, if a 50%-50% load balancing policy is specified in the upstream direction, then the UE 40 will schedule half of the total IP flow traffic on the 3GPP access interface (first sub-flow) and half of the total IP flow traffic on the WLAN access interface (second sub-flow).

In more general terms, a method for implementing the described IP flow splitting technique, using the terminology above, may be defined as follows:
UE discovers FCSF;
UE detects an existing or requested IP traffic flow that matches a filter rule in the applicable, and typically local ISSP;
Based on the filter rule in the ISSP, the UE determines that the IP traffic flow can be transmitted across a first radio access interface and a second radio access interface;
UE establishes a first communication path to a proxy server (for example the FCSF) over the first radio access interface and transmits all parts of the IP traffic flow to the proxy server over the first communication path
UE establishes connectivity to the second radio access interface specified by the prioritized accesses in the ISSP;
UE exchanges with proxy server information for facilitating the establishment of a second communication path between UE and the proxy server over the second radio access interface;
In response to exchanging information, a second communication path between UE and proxy server is established over the second access network
Parts of said IP traffic flow are now transmitted between UE and proxy server as a first sub-flow over the first communication path and parts of said IP traffic flow are transmitted between UE and proxy server as a second sub-flow over the second communication path.

Splitting the same IP flow across different radio access interfaces as discussed above can bring considerable benefits, including increased data throughput, increased network availability, increased network reliability, enhanced mobility support, and fine-grained offload. Each of these aspects will be briefly discussed in turn below.

Using two radio accesses to transmit an IP flow can significantly increase the overall throughput provided to the application layer. This is true especially when the individual throughputs of radio accesses are comparable.

When one radio access becomes temporarily unavailable (e.g. due to slow-fading propagation), the other radio access could be used to carry all the flow traffic. The fading characteristics of heterogeneous radio accesses are highly uncorrelated, for example due to different transmission schemes, frequencies and traffic loads, and, thus, the probability that both radio accesses simultaneously experience deep-fade conditions is very small.

Real-time IP flows, which are usually transmitted in unacknowledged mode, can be received with large packet error rate when transmitted over low quality communication paths. Using access network diversity to transmit such flows (e.g. transmit some or all packets on both 3GPP and WLAN accesses) can significantly reduce the received packet error rate, thus improving communication reliability.

Transmitting a single IP flow over heterogeneous access networks can provide an effect similar to vertical soft-handovers. For example, if the UE discovers and connects to a WLAN access while it receives a video stream over E-UTRAN, the UE could setup a second communication path over WLAN to support the ongoing video stream. The streaming traffic could then be load-balanced across WLAN and E-UTRAN, and as the user moves out of LTE coverage, the path over WLAN could take over all streaming traffic.

According to current 3GPP specifications, the UE can be configured (with inter-system mobility policies) to steer selected IP flows to 3GPP access and offload other flows to WLAN access. If the UE can also be configured to steer selected IP sub-flows to 3GPP access and offload other sub-flows to WLAN access, then a fine-grained offload mechanism can be realized. With such mechanism, the operator would be able to load-balance selected traffic across e.g. 3GPP access and WLAN access.

In the foregoing specification, the invention has been described with reference to specific examples of embodiments of the invention. It will, however, be evident that various modifications and changes may be made therein without departing from the broader scope of the invention as set forth in the appended claims.

Some of the above embodiments, as applicable, may be implemented using a variety of different processing systems. For example, the Figures and the discussion thereof describe an exemplary architecture and method which is presented merely to provide a useful reference in discussing various aspects of the disclosure. Of course, the description of the architecture and method has been simplified for purposes of discussion, and it is just one of many different types of appropriate architectures and methods that may be used in accordance with the disclosure. Those skilled in the art will recognize that the boundaries between program elements are merely illustrative and that alternative embodiments may merge elements or impose an alternate decomposition of functionality upon various elements.

1. A wireless communication device for use in a wireless communication system to communicate an IP flow, the wireless communication device being adapted to communicate over at least two radio access interfaces of different types, the wireless communication device being further adapted to selectively communicate said IP flow either over a single radio access interface, or with a proxy function distant from the wireless communication device as concurrent sub-flows over at least two of the radio access interfaces.

2. The wireless communication device of claim 1 wherein the at least two of the radio access interfaces are of heterogeneous types.

3. The wireless communication device of claim 2 wherein a first of said at least of the two heterogeneous radio access interfaces is a cellular interface, and a second of the at least of the two radio access interfaces is not a cellular interface.

4. The wireless communication device of claim 3 wherein a second of the least two of the radio access interfaces is one of a wireless LAN, and a Bluetooth interface.

5. The wireless communication device of claim 1 further arranged to divide communication of said IP flow between the sub-flows over said at least two of the radio access interfaces.

6. The wireless communication device of claim 1 further arranged to duplicate at least a part of said IP flow between the sub-flows over said at least two of the radio access interfaces.

7. The wireless communication device of claim 1 wherein the IP flow is coupled to an application layer in the wireless communication device, and the wireless communication device comprises a flow split/combine function arranged to communicate the IP flow with the application layer and concurrently as said sub-flows over said at least two of the radio access interfaces.

8. The wireless communication device of claim 1 adapted to implement one or more policies to decide over which single or multiple ones of said radio access interfaces to communicate said IP flow.

9. The wireless communication device of claim 8 adapted to implement said one or more policies to change the routing of the IP flow from concurrently over multiple radio access interfaces to over at least one less of said radio access interfaces by ceasing the routing over a particular one of said radio access interfaces.

10. The wireless communication device of claim 8 further arranged to receive said policies over one or more of the radio access interfaces.

11. The wireless communication device of claim 9 wherein said change of routing to at least one less of said radio access interfaces is responsive to at least one of: a determination of poor quality of service over, and a determination of lack of access to, said particular one of the radio access interfaces.

12. The wireless communication device of claim 9 wherein the change of routing is from two to one of said radio access interfaces.

13. The wireless communication device of claim 8 adapted to implement said one or more policies to change the routing of said IP flow from over a single one of said radio access interfaces to concurrently over multiple ones of said radio access interfaces.

14. The wireless communication device of claim 13 adapted to negotiate with the proxy function to set up communication of said IP flow as multiple sub-flows over multiple ones of said radio access interfaces between said wireless communication device and said proxy function, and to set up communication of said IP flow as an unsplit IP flow between the proxy function and a network node distant from the wireless communication device.

15. A wireless communication system comprising:
at least one wireless communication device as set out in claim 1;
a network node distant from the wireless communication device; and
said proxy function distant from the wireless communication device and configured to communicate the IP flow with the wireless communication device concurrently as sub-flows over at least two of the radio access interfaces, to communicate the selected IP flow as a consolidated, unsplit flow with the network node.

16. The wireless communication system of claim 15 wherein the IP flow is at least one of a UDP flow and a TCP flow.

17. The wireless communication system of claim 15 wherein the IP flow consists of IP packets passed through a single IP filter rule.

18. The wireless communication system of claim 15 wherein the IP flow consists of IP packets having one or more of: the same IP destination address, the same port number; carrying data according to the same IP protocol; and the same originating application at the wireless communication device.

19. The wireless communication system of claim 13 wherein the proxy function is adapted to negotiate with the wireless communication device to set up communication of said IP flow as multiple sub-flows over multiple ones of said radio access interfaces between said wireless communication device and said proxy function, and to set up communication of said IP flow as an unsplit IP flow between the proxy function and a network node distant from the wireless communication device.

20. A method of routing data in a wireless communication system using a wireless communication device adapted to communicate over at least two heterogeneous radio access interfaces, comprising:
providing a proxy function distant from the wireless communication device;
communicating an IP flow between the wireless communication device and the proxy function as concurrent sub-flows over at least two of the radio access interfaces; and
communicating the IP flow as an unsplit flow between the proxy function and another network node.

21. The method of claim 20 wherein a first of said at least two of the radio access interfaces is a cellular radio interface.

22. The method of claim 21 wherein a second of the said at least two of the radio access interfaces is one of: a wireless LAN interface and a bluetooth interface.

23. The method of claim 20 further comprising implementing one or more policies at the wireless communications device to determine over which single or multiple radio access interfaces a particular IP flow is to be communicated.

24. The method of claim 20 further comprising, before communicating the IP flow as concurrent sub-flows:
negotiating between the proxy function and the wireless communication device to arrange communication of the IP flow as concurrent sub-flows over at least two of the radio access interfaces.

25. A method of operating a wireless communication system comprising a user equipment provided with at least first and second radio access interfaces and arranged to communicate an IP traffic flow with a distant network node, the method comprising:
providing a proxy server distant from the user equipment;
providing an inter system sub-flow policy having at least one filter rule and specifying network access priorities;
the user equipment carrying out a network discovery of the proxy server;
the user equipment detecting an existing or requested IP traffic flow that matches a said filter rule in the inter system sub-flow policy;
based on the matched filter rule, the user equipment determining that the IP traffic flow can be transmitted across both said first radio access interface and said second radio access interface;
the user equipment establishing a first communication path to the proxy server over the first radio access interface and communicating the IP traffic flow to the proxy server over the first communication path;
the user equipment establishing connectivity to the second radio access interface specified by the network access priorities;
the user equipment exchanging with the proxy server information for facilitating the establishment of a second communication path between the user equipment and the proxy server over the second radio access interface;
in response to exchanging information, establishing a second communication path between the user equipment and the proxy server over the second access network;
transmitting parts of said IP traffic flow between the user equipment and the proxy server as a first sub-flow over the first communication path and parts of said IP traffic flow between the user equipment and the proxy server as a second sub-flow over the second communication path; and
the proxy server combining together the first sub-flow and the second sub-flow and forwarding the combined sub-flows to the distant network node.

26. The method of claim 25 wherein the inter system sub-flow policy is held at the user equipment.

27. The method of claim 25 providing the inter system sub-flow policy to the user equipment over at least one of said first and second radio access interfaces.
